(19) United States
(12) Patent Application Publication
(10) Pub. No.: US 2024/0368458 A1
(43) Pub. Date: Nov. 7, 2024

(54) WATER-SOLUBLE GRAPHENE OXIDE NANOSHEET ASSISTED HIGH TEMPERATURE FRACTURING FLUID

(71) Applicant: Saudi Arabian Oil Company, Dhahran (SA)

(72) Inventors: Feng Liang, Cypress, TX (US); Ashok Santra, The Woodlands, TX (US); Adrian Buenrosetro, Udhailiyah (SA)

(21) Appl. No.: 18/774,191

(22) Filed: Jul. 16, 2024

Related U.S. Application Data
(62) Division of application No. 17/496,608, filed on Oct. 7, 2021, now Pat. No. 12,071,589.

(51) Int. Cl. C09K 8/66; C09K 8/68

(52) U.S. Cl. CPC C09K 8/665; C09K 8/685

(57) ABSTRACT

This disclosure relates to a fracturing fluid including an acrylamide-based copolymer, a graphene oxide additive, and a crosslinker, and methods of using the fracturing fluid to reduce fluid friction during treatment of a subterranean formation.

### CROSS-REFERENCE TO RELATED PATENT APPLICATIONS

This application is a divisional of and claims the benefit of priority to U.S. patent application Ser. No. 17/496,608, filed on Oct. 7, 2021, the contents of which are incorporated by reference herein.

### TECHNICAL FIELD

This document relates to methods and compositions used in hydraulic fracturing operations, such as those that operate at temperatures of about 300° F. or higher.

### BACKGROUND

The reduction of friction during fracturing treatment in the oilfield is an ongoing challenge. Slickwater is the primary type of fracturing fluid used in hydraulic fracturing treatment. Since water is a Newtonian fluid, it generates high treatment pressures due to friction pressure loss at high pumping rates. To reduce the friction pressure, a low concentration of high molecular weight acrylamide-based polymers is often added to the fluid (referred to as slickwater treatment). However, due to the relative low viscosity, the slickwater treatment can only carry about 0.2-2 pound per gallon (ppg) of proppants and is also typically pumped at a higher pumping rate, for example, about 60-110 barrels per minutes (bpm).

Crosslinked fracturing fluids such as polysaccharide-based fluids are designed to transport higher proppant concentrations and reduce leakoff. Guar-based fracturing fluids are commonly used primarily because of their abundance, relative low cost, and capability to work at up to 350° F. when formulated at high pH (for example, greater than 9.5). One notable disadvantage for most guar-based fracturing fluids, however, is the insoluble residue in guar which tends to cause permeability reduction. Another disadvantage for using guar-based fluids at high pH is the tendency for forming divalent ion scales at high pH. In general, thermally stable synthetic polymers, such as acrylamide-based polymers are considered to be residue-free. These polymers can be used for preparing fracturing fluids at temperatures around 300° F.-450° F. or higher. However, a high dosage of acrylamide-based polymers may still cause formation damage due to factors such as incomplete degradation.

Therefore, there is a need for a fluid system for use in hydraulic fracturing treatment that is stable at high temperatures, such as about 300° F.-450° F. or higher, and is able to reduce the fluid viscosity and friction during pumping.

### SUMMARY

Provided in the present disclosure is a fracturing fluid and methods of treating a subterranean formation with the fracturing fluid. In some embodiments, provided is a fracturing fluid comprising an aqueous copolymer composition comprising an acrylamide-based copolymer; a graphene oxide (GO) additive; and a crosslinker comprising a metal.

In some embodiments of the fracturing fluid, the acrylamide-based polymer is a copolymer comprising acrylamide and acrylic acid. In some embodiment, the acrylamide-based polymer is a terpolymer comprising 2-acrylamido-2-methylpropanesulfonic acid, acrylamide, and acrylic acid monomer units, or a salt thereof. In some embodiments, the copolymer comprises about 1 mol % to about 55 mol %, about 1 mol % to about 40 mol %, or about 1 mol % to about 25 mol % of the 2-acrylamido-2-methylpropanesulfonic acid monomer units. In some embodiments, the fracturing fluid comprises about 15 to about 50 pounds of the copolymer per thousand gallons (pptg) of the fracturing fluid.

In some embodiments of the fracturing fluid, the graphene oxide additive is water-soluble graphene oxide. In some embodiments, the graphene oxide additive is bifacial grafted graphene oxide nanosheets. In some embodiments, the bifacial grafted graphene oxide nanosheets are hydrophilically modified. In some embodiments, the bifacial grafted graphene oxide nanosheets are modified with homopolymers, copolymers, or terpolymers of 2-acryamido-2-methyl-1-propanesulfonic acid (AMPS), acrylic acid (AA), acrylamide (AM), and combinations thereof. In some embodiments, the graphene oxide additive is hydrophilically-modified GO-AMPS-AA. In some embodiments, the fracturing fluid comprises about 0.01 pptg to about 20 pptg, about 0.1 pptg to about 10 pptg, or about 0.25 pptg to about 5 pptg of the graphene oxide additive.

In some embodiments of the fracturing fluid, the crosslinker comprises zirconium, titanium, or chromium. In some embodiments, the weight ratio of the metal to the copolymer is in a range of 0.01 to 0.10.

In some embodiments, the fracturing fluid comprises at least one of a gel stabilizer, a clay stabilizer, a viscosity breaker, a proppant, and a pH adjusting agent.

In some embodiments, the fracturing fluid comprises a pH adjusting agent, wherein the pH of the fracturing fluid is between about 2 to about 7 or about 5 to about 6.

In some embodiments, the fracturing fluid comprises between about 250 mg/L and about 50,000 mg/L of total dissolved solids.

In some embodiments, the fracturing fluid has a viscosity that is reduced by about 5% to about 65% as compared to the same fracturing fluid that does not contain the graphene oxide additive.

Also provided is a method of treating a subterranean formation. In some embodiments, the method comprises introducing a fracturing fluid into a subterranean formation, the fracturing fluid comprising: an aqueous copolymer composition comprising an acrylamide-based copolymer; a graphene oxide (GO) additive selected from a non-modified water-soluble graphene oxide and a bifacial hydrophilically-modified graphene oxide; and a crosslinker comprising a metal; and crosslinking the fracturing fluid in the subterranean formation to yield a crosslinked fracturing fluid.

In some embodiments of the method, the fracturing fluid comprises about 0.01 pptg to about 20 pptg, about 0.1 pptg to about 10 pptg, or about 0.25 pptg to about 5 pptg of the graphene oxide additive.

Also provided in the present disclosure is a method of reducing fluid friction during treatment of a subterranean formation. In some embodiments, the method comprises introducing a fracturing fluid into a subterranean formation, the fracturing fluid comprising: an aqueous copolymer composition comprising an acrylamide-based copolymer; a graphene oxide (GO) additive selected from a non-modified water-soluble graphene oxide and a bifacial hydrophilically-modified graphene oxide; and a crosslinker comprising a metal; and crosslinking the fracturing fluid in the subterranean formation to yield a crosslinked fracturing fluid.

In some embodiments of the method, the fracturing fluid comprises about 0.01 pptg to about 20 pptg, about 0.1 pptg to about 10 pptg, or about 0.25 pptg to about 5 pptg of the graphene oxide additive.

### DESCRIPTION OF DRAWINGS

FIG. 1 shows a plot of viscosity versus time for a crosslinked fracturing fluid that does not contain a graphene oxide (GO) additive.

FIG. 2 shows a plot of viscosity versus time for a crosslinked fracturing fluid that does not contain a GO additive and exemplary crosslinked fracturing fluids containing non-modified GO.

FIG. 3 shows a plot of viscosity versus time for a crosslinked fracturing fluid that does not contain a GO additive and exemplary crosslinked fracturing fluids containing a hydrophilic-modified GO additive.

FIG. 4 shows the breaking profile of an exemplary crosslinked fracturing fluid that contains an encapsulated oxidizer.

### DETAILED DESCRIPTION

Graphene, being a two-dimensional material, possesses unique anti-wear and friction reduction performances, which are typically not found in traditional materials. For example, superlubricity (an extremely low coefficient of friction (COF) of less than 0.01) can be attained between graphene layers at nanoscale and microscale friction tests. However, graphene is not readily soluble in water. Thus, provided in the present disclosure are methods of using water-soluble graphene oxide (GO) and bifacial hydrophilically-modified graphene oxide (GO) nanosheets to reduce the friction for crosslinked acrylamide-based high temperature fracturing fluids. Also provided are fracturing fluids containing a GO additive, such as water-soluble GO or bifacial hydrophilically-modified GO. In some embodiments, the fracturing fluid containing the water-soluble GO or bifacial hydrophilically-modified GO nanosheets additive is stable at high temperatures, such as about 300° F. or higher. In some embodiments, the fracturing fluid containing the water-soluble GO or bifacial hydrophilically-modified GO nanosheets additive has a lower viscosity that the same fracturing fluid without the additive. In some embodiments, addition of the water-soluble GO or bifacial hydrophilically-modified GO nanosheets additive to a crosslinked acrylamide-based high temperature fracturing fluid reduces the friction of the fluid system as compared to the same fracturing fluid without the additive.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

As used herein, the term “polymer” refers to a molecule having at least one repeating unit and can include copolymers. The term “copolymer” as used herein refers to a polymer that includes at least two different repeating units. A copolymer can include any suitable number of repeating units. The term “terpolymer” refers to a polymer synthesized from three different monomers.

As used herein, the term “fracturing fluid” refers to fluids or slurries used downhole during hydraulic fracturing operations.

As used herein, the term “fluid” refers to gases, liquids, gels, slurries with a high solids content, and critical and supercritical materials.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, water control, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### High Temperature Fracturing Fluids

Provided in the present disclosure are high temperature fracturing fluids that contain a base polymer and an additive that is water-soluble graphene oxide (GO) or bifacial hydrophilically-modified graphene oxide (GO) nanosheets. In some embodiments, the fracturing fluid includes an aqueous composition including a copolymer and a crosslinking solution including a crosslinker. The crosslinked fracturing fluids include a crosslinked product of the copolymer and the crosslinker.

### Base Polymer

The fracturing fluids of the present disclosure contain a base polymer. In some embodiments, the base polymer is an acrylamide-based polymer that contains carboxylic acid functionality. Examples of such polymers include, but are not limited to, copolymers of acrylamide (AM) and acrylic acid (AA) or terpolymers. In some embodiments, the terpolymer includes acrylamide (AM), acrylic acid (AA), and 2-acrylamido-2-methylpropanesulfonic acid (AMPS). The acrylic acid monomer units may be in the form of a salt of acrylic acid.

In some embodiments, the copolymer includes at least three monomer units. In some embodiments, the three monomer units are 2-acrylamido-2-methylpropanesulfonic acid (AMPSA), acrylamide, and acrylic acid or a related salt thereof. The copolymer typically has less than about 55 mol % of AMPSA. In some embodiments, the copolymer has less than about 20 mol % AMPSA. In some embodiments, the copolymer has between about 1 mol % and about 55 mol %, between about 1 mol % and about 40 mol %, between about 1 mol % and about 25 mol %, between about 10 mol % and about 30 mol %, between about 12 mol % and about 20 mol %, or between about 13 mol % and about 17 mol % AMPSA. In some embodiments, the copolymer has about 1 mol %, about 5 mol %, about 10 mol %, about 20 mol %, about 25 mol %, about 30 mol %, about 35 mol %, about 40 mol %, about 45 mol %, about 50 mol %, or about 55 mol % AMPSA. In some embodiments, the copolymer has about 15 mol % of the AMPSA. In some embodiments, the copolymer has about 0.1 mol % to about 30 mol % of acrylic acid.

In some embodiments, the copolymer is a terpolymer that includes AMPSA, acrylamide, and acrylic acid or a related salt thereof. In some embodiments, the terpolymer has less than about 55 mol % AMPSA. In some embodiments, the terpolymer has less than about 20 mol % AMPSA. In some embodiments, the terpolymer has between about 5 mol % and about 40 mol %, between about 10 mol % and about 30 mol %, between about 12 mol % and about 20 mol %, or between about 13 mol % and about 17 mol % AMPSA. In some embodiments, the terpolymer has about 5 mol %, about 10 mol %, about 20%, about 25 mol %, about 30 mol %, about 35 mol %, about 40 mol %, about 45 mol %, about 50 mol %, or about 55 mol % AMPSA. In some embodiments, the terpolymer contains about 15 mol % AMPSA. In some embodiments, the terpolymer has about 0.1 mol % to about 30 mol % of acrylic acid. In some embodiments, the amount of acrylic acid is greater than 0 mol %.

In some embodiments, the copolymer or terpolymer is a copolymer or terpolymer such as disclosed in U.S. Pat. No. 10,144,866, which is hereby incorporated by reference in its entirety.

In some embodiments, a terpolymer of AMPSA, acrylamide, and acrylic acid or a related salt thereof is obtained by copolymerizing AMPSA, acrylic acid, and acrylamide in specified amounts. In some embodiments, the terpolymer is produced by initially polymerizing AMPSA and acrylamide, and hydrolyzing the acrylamide to generate desired amounts of acrylic acid, such that the number of moles of acrylamide and acrylic acid monomer units is equal to the total number of moles of acrylamide initially employed. The copolymer can be employed as water-in-oil emulsion or suspension concentrate, or as a solid dissolved in an aqueous fluid.

### Crosslinkers

The fracturing fluids of the present disclosure contain a crosslinker. In some embodiments, the fracturing fluids include low ratios of crosslinker to copolymer. Suitable crosslinkers typically include a metal. In some embodiments, the crosslinker includes a metal or metal oxide. Exemplary metals include, but are not limited to, zirconium, titanium, and chromium.

In some embodiments, the crosslinker includes zirconium. Suitable zirconium crosslinkers include, but are not limited to, zirconium complexes in which zirconium is complexed with ligands such as lactate salts (for example, sodium zirconium lactate), triethanolamines, alkoxides (for example, isopropoxide and propoxide), 2,2′-iminodiethanol, and mixtures thereof. In some embodiments, the crosslinker is dissolved in aqueous fluids, non-aqueous fluids, or liquids (for example, alcohol such as n-propanol), and a combination of aqueous, water-miscible non-aqueous solvents (for example, alcohols and aminoalcohols). TYZOR® 212, a Zr crosslinker that contains 16.75 wt % ZrO₂ and 12.4 wt % Zr, is available from Dorf Ketal as a solution in n-propanol, is one example of a Zr crosslinker. In some embodiments, the fracturing fluid contains the copolymer or terpolymer as described herein and the crosslinking solution TYZOR® 212. In some embodiments, the fracturing fluid contains about 20 pptg to about 30 pptg of the copolymer or terpolymer and the crosslinking solution TYZOR® 212.

In some embodiments, a crosslinking solution includes about 7 wt % to about 20 wt % of a metal crosslinker. In some embodiments, the fracturing fluid contains about 0.1 gallon per one thousand gallon (gpt) to about to about 5.0 gpt of the crosslinker, such as about 0.1 gpt to about 4.5 gpt, about 0.1 gpt to about 4.0 gpt, about 0.1 gpt to about 3.5 gpt, about 0.1 gpt to about 3.0 gpt, about 0.1 gpt to about 2.5 gpt, about 0.1 gpt to about 2.0 gpt, about 0.1 gpt to about 1.5 gpt, about 0.1 gpt to about 1.0 gpt, about 0.1 gpt to about 0.8 gpt, about 0.1 gpt to about 0.6 gpt, about 0.1 gpt to about 0.4 gpt, about 0.4 gpt to about 5.0 gpt, about 0.4 gpt to about 4.5 gpt, about 0.4 gpt to about 4.0 gpt, about 0.4 gpt to about 3.5 gpt, about 0.4 gpt to about 3.0 gpt, about 0.4 gpt to about 2.5 gpt, about 0.4 gpt to about 2.0 gpt, about 0.4 gpt to about 1.5 gpt, about 0.4 gpt to about 1.0 gpt, about 0.4 gpt to about 0.8 gpt, about 0.4 gpt to about 0.6 gpt, about 0.6 gpt to about 5.0 gpt, about 0.6 gpt to about 4.5 gpt, about 0.6 gpt to about 4.0 gpt, about 0.6 gpt to about 3.5 gpt, about 0.6 gpt to about 3.0 gpt, about 0.6 gpt to about 2.5 gpt, about 0.6 gpt to about 2.0 gpt, about 0.6 gpt to about 1.5 gpt, about 0.6 gpt to about 1.0 gpt, about 0.6 gpt to about 0.8 gpt, about 0.8 gpt to about 5.0 gpt, about 0.8 gpt to about 4.5 gpt, about 0.8 gpt to about 4.0 gpt, about 0.8 gpt to about 3.5 gpt, about 0.8 gpt to about 3.0 gpt, about 0.8 gpt to about 2.5 gpt, about 0.8 gpt to about 2.0 gpt, about 0.8 gpt to about 1.5 gpt, about 0.8 gpt to about 1.0 gpt, about 1.0 gpt to about 5.0 gpt, about 1.0 gpt to about 4.5 gpt, about 1.0 gpt to about 4.0 gpt, about 1.0 gpt to about 3.5 gpt, about 1.0 gpt to about 3.0 gpt, about 1.0 gpt to about 2.5 gpt, about 1.0 gpt to about 2.0 gpt, about 1.0 gpt to about 1.5 gpt, about 1.5 gpt to about 5.0 gpt, about 1.5 gpt to about 4.5 gpt, about 1.5 gpt to about 4.0 gpt, about 1.5 gpt to about 3.5 gpt, about 1.5 gpt to about 3.0 gpt, about 1.5 gpt to about 2.5 gpt, about 1.5 gpt to about 2.0 gpt, about 2.0 gpt to about 5.0 gpt, about 2.0 gpt to about 4.5 gpt, about 2.0 gpt to about 4.0 gpt, about 2.0 gpt to about 3.5 gpt, about 2.0 gpt to about 3.0 gpt, about 2.0 gpt to about 2.5 gpt, about 2.5 gpt to about 5.0 gpt, about 2.5 gpt to about 4.5 gpt, about 2.5 gpt to about 4.0 gpt, about 2.5 gpt to about 3.5 gpt, about 2.5 gpt to about 3.0 gpt, about 3.0 gpt to about 5.0 gpt, about 3.0 gpt to about 4.5 gpt, about 3.0 gpt to about 4.0 gpt, about 3.0 gpt to about 3.5 gpt, about 3.5 gpt to about 5.0 gpt, about 3.5 gpt to about 4.5 gpt, about 3.5 gpt to about 4.0 gpt, about 4.0 gpt to about 5.0 gpt, about 4.0 gpt to about 4.5 gpt, about 4.5 gpt to about 5.0 gpt, or about 0.1 gpt, about 0.2 gpt, about 0.3 gpt, about 0.4 gpt, about 0.5 gpt, about 0.6 gpt, about 0.7 gpt, about 0.8 gpt, about 0.9 gpt, about 1.0 gpt, about 1.5 gpt, about 2.0 gpt, about 2.5 gpt, about 3.0 gpt, about 3.5 gpt, about 4.0 gpt, or about 5.0 gpt of crosslinker. In some embodiments, the fracturing fluid contains about 0.6 gpt crosslinker. In some embodiments, the crosslinker contains Zr.

In some embodiments, the weight ratio of Zr to copolymer or terpolymer is about 0.01 to about 0.10, such as about 0.02 to about 0.08, about 0.02 to about 0.06, about 0.02 to about 0.03, or about 0.01, about 0.02, about 0.03, about 0.04, about 0.05, about 0.06, about 0.07, about 0.08, about 0.09, or about 0.10. In some embodiments, the weight ratio of Zr to copolymer or terpolymer is about 0.02 to about 0.03. In some embodiments, the weight ratio of Zr to copolymer or terpolymer is about 0.024.

Crosslinkers suitable for use in the fracturing fluids of the present disclosure include titanium (Ti) crosslinkers. Suitable titanate crosslinkers include, but are not limited to, titanate crosslinkers with ligands such as lactates and triethanolamines, and mixtures thereof, optionally delayed with hydroxyacetic acid. Crosslinkers suitable for fracturing fluid may also include aluminum (Al) crosslinkers, chromium (Cr) crosslinkers, iron (Fe) crosslinkers, hafnium (Hf) crosslinkers, and combinations thereof.

The copolymers provided in the present disclosure can be combined with crosslinkers to produce crosslinked fluids that function as efficient proppant transportation fluids at low polymer loadings. For example, a fracturing fluid having a copolymer concentration of less than about 30 pounds per thousand gallons (pptg) can produce crosslinked fluids when combined with a crosslinker, even at a low crosslinker/copolymer ratio, for use at about 450° F. or higher. In some embodiments, the fracturing fluid contains about 15 pound per one thousand gallons (pptg) to about 50 pptg of the copolymer or terpolymer, such as about 15 pptg to about 45 pptg, about 15 pptg to about 40 pptg, about 15 pptg to about 35 pptg, about 15 pptg to about 30 pptg, about 15 pptg to about 25 pptg, about 15 pptg to about 20 pptg, about 20 pptg to about 50 pptg, about 20 pptg to about 45 pptg, about 20 pptg to about 40 pptg, about 20 pptg to about 35 pptg, about 20 pptg to about 30 pptg, about 20 pptg to about 25 pptg, about 25 pptg to about 50 pptg, about 25 pptg to about 45 pptg, about 25 pptg to about 40 pptg, about 25 pptg to about 35 pptg, about 25 pptg to about 30 pptg, about 30 pptg to about 50 pptg, about 30 pptg to about 45 pptg, about 30 pptg to about 40 pptg, about 30 pptg to about 35 pptg, about 35 pptg to about 50 pptg, about 35 pptg to about 45 pptg, about 35 pptg to about 40 pptg, about 40 pptg to about 50 pptg, about 40 pptg to about 45 pptg, about 45 pptg to about 50 pptg, or about 15 pptg, about 20 pptg, about 25 pptg, about 30 pptg, about 35 pptg, about 40 pptg, about 45 pptg, or about 50 pptg of the copolymer or terpolymer. In some embodiments, the fracturing fluid contains about 25 pptg of the copolymer or terpolymer. In some embodiments, for a 300° F. application, a fracturing fluid including a copolymer at a concentration of about 25 pptg is used.

Fracturing fluids provided herein can be used at temperatures between about 300° F. and about 450° F. or higher, and typically have a pH in a range of 2 to 7, such as 5 to 7 or 5 to 5.5 or 5.5 to 6.5.

### Graphene Oxide and Graphene Oxide Nanosheets

The fracturing fluids of the present disclosure contain water-soluble graphene oxide (GO) or its bifacial hydrophilically-modified (or grafted) GO nanosheets. The term “graphene oxide,” as used herein, refers to sp² carbon sheets produced by oxidative exfoliation of graphite. The graphene oxide additive used in the fracturing fluids of the present disclosure is water-soluble. In some embodiments, the graphene oxide additive in the fracturing fluid is a non-modified water-soluble graphene oxide. In some embodiments, the GO is modified, for example, with hydrophilic groups. In some embodiments, the GO is bifacially modified or grafted with hydrophilic groups. In some embodiments the GO additive is bifacial grafted graphene oxide with homo-, co- or terpolymers. In some embodiments, the GO is bifacially grafted with homo-, co-, or terpolymers containing AMPS, AA, AM, and combinations thereof. In some embodiments, the GO is bifacially grafted with a hydrophilic polymeric side chains such as polyethylene glycol (PEG). In some embodiments, the fracturing fluid contains non-modified GO. In some embodiments, the fracturing fluid contains AMPS-AA grafted GO. Without wishing to be bound by any particular theory, it is believed that the water-soluble GO or its bifacial hydrophilically modified graphene serves as a lubricant among the crosslinked polymeric network to reduce the friction during pumping.

In some embodiments, the graphene oxide nanosheet has a thickness in the range of about 0.001 microns (m) to about 10 μm, such as about 0.001 μm to about 7 μm, about 0.001 μm to about 5 μm, about 0.001 μm to about 2 μm, about 0.001 μm to about 1 μm, about 0.001 μm to about 0.5 μm, about 0.001 μm to about 0.01 μm, about 0.01 μm to about 10 μm, about 0.01 μm to about 7 μm, about 0.01 μm to about 5 μm, about 0.01 μm to about 2 μm, about 0.01 μm to about 1 μm, about 0.01 μm to about 0.5 μm, about 0.5 μm to about 10 μm, about 0.5 μm to about 7 μm, about 0.5 μm to about 5 μm, about 0.5 μm to about 2 μm, about 0.5 μm to about 1 μm, about 1 μm to about 10 μm, about 1 μm to about 7 μm, about 1 μm to about 5 μm, about 1 μm to about 2 μm, about 2 μm to about 10 μm, about 2 μm to about 7 μm, about 2 μm to about 5 μm, about 5 μm to about 10 μm, about 5 μm to about 7 μm, about 7 μm to about 10 μm, or about 0.001 μm, about 0.005 μm, about 0.01 μm, about 0.05 μm, about 0.1 μm, about 0.5 μm, about 1 μm, about 2 μm, about 3 μm, about 4 μm, about 5 μm, about 6 μm, about 7 μm, about 8 μm, about 9 μm, or about m.

In some embodiments, the graphene oxide nanosheet has a lateral dimension in the range of about 0.02 μm to about 50 μm, such as about 0.02 μm to about 40 μm, about 0.02 μm to about m, about 0.02 μm to about 20 μm, about 0.02 μm to about 10 μm, about 0.02 μm to about 5 m, about 0.02 μm to about 1 μm, about 0.02 μm to about 0.5 μm, about 0.02 μm to about 0.1 μm, about 0.1 μm to about 50 μm, about 0.1 μm to about 40 μm, about 0.1 μm to about 30 μm, about 0.1 μm to about 20 μm, about 0.1 μm to about 10 μm, about 0.1 μm to about 5 μm, about 0.1 μm to about 1 μm, about 0.1 μm to about 0.5 μm, about 0.5 μm to about 50 μm, about 0.5 μm to about 40 μm, about 0.5 μm to about 30 μm, about 0.5 μm to about 20 μm, about 0.5 μm to about 10 μm, about 0.5 μm to about 5 μm, about 0.5 μm to about 1 μm, about 1 μm to about 50 μm, about 1 μm to about 40 μm, about 1 μm to about 30 μm, about 1 μm to about 20 μm, about 1 μm to about 10 am, about 1 μm to about 5 μm, about 5 μm to about 50 μm, about 5 μm to about 40 μm, about 5 m to about 30 μm, about 5 μm to about 20 μm, about 5 μm to about 10 μm, about 10 μm to about 50 μm, about 10 μm to about 40 μm, about 10 μm to about 30 μm, about 10 μm to about 20 μm, about 20 μm to about 50 μm, about 20 μm to about 40 μm, about 20 μm to about 30 μm, about 30 m to about 50 μm, about 30 μm to about 40 μm, about 40 μm to about 50 μm, or about 0.02 μm, about 0.05 μm, about 0.1 μm, about 0.5 μm, about 1 μm, about 5 μm, about 10 μm, about 15 μm, about 20 μm, about 25 μm, about 30 μm, about 35 μm, about 40 μm, about 45 μm, or about 50 μm.

In some embodiments, the concentration of the water-soluble graphene oxide or its bifacial hydrophilically modified/grafted graphene oxide nanosheet in the fracturing fluid system ranges from about 0.01 pptg to 20 pptg, such as about 0.01 pptg to about 15 pptg, about 0.01 pptg to about 10 pptg, about 0.01 pptg to about 5 pptg, about 0.01 pptg to about 1 pptg, about 0.01 pptg to about 0.1 pptg, about 0.1 pptg to 20 pptg, about 0.1 pptg to about 15 pptg, about 0.1 pptg to about 10 pptg, about 0.1 pptg to about 5 pptg, about 0.1 pptg to about 1 pptg, about 1 pptg to 20 pptg, about 1 pptg to about 15 pptg, about 1 pptg to about 10 pptg, about 1 pptg to about 5 pptg, about 5 pptg to 20 pptg, about 5 pptg to about 15 pptg, about 5 pptg to about 10 pptg, about 10 pptg to 20 pptg, about 10 pptg to about 15 pptg, about 15 pptg to 20 pptg, or about 0.01 pptg, about 0.05 pptg, about 0.1 pptg, about 0.25 pptg, about 0.5 pptg, about 1 pptg, about 2 pptg, about 3 pptg, about 4 pptg, about 5 pptg, about 10 pptg, about 15 pptg, or about 20 pptg. In some embodiments, the concentration of the water-soluble graphene oxide or its bifacial hydrophilically modified/grafted graphene oxide nanosheet in the fracturing fluid system is about 0.1 pptg to 5 about pptg. In some embodiments, the concentration of the water-soluble graphene oxide or its bifacial hydrophilically modified/grafted graphene oxide nanosheet in the fracturing fluid system is about 0.25 pptg. In some embodiments, the concentration of the water-soluble graphene oxide or its bifacial hydrophilically modified/grafted graphene oxide nanosheet in the fracturing fluid system is about 1 pptg. In some embodiments, the concentration of the water-soluble graphene oxide or its bifacial hydrophilically modified/grafted graphene oxide nanosheet in the fracturing fluid system is about 2 pptg.

### Aqueous Carrier

In some embodiments, the fracturing fluids of the present disclosure are formed by mixing a copolymer or terpolymer provided herein with an aqueous carrier, such as water. The aqueous carrier can include water, fresh water, brine, produced water, flowback water, brackish water, Arab-D-brine, sea water, or combinations thereof. In some embodiments, the water is field water. In some embodiments, the field water has less than about 50,000 mg/L of total dissolved solids (TDS). In some embodiments, the field water has between about 250 mg/L and about 50,000 mg/L TDS. In some cases, the field water has between about 250 mg/L and about 20,000 mg/L TDS, between about 400 mg/L and about 10,000 mg/L TDS, between about 500 mg/L and about 2000 mg/L TDS, or between about 600 mg/L and about 1000 mg/L TDS. In some cases, the field water has about 500 mg/L TDS, about 600 mg/L TDS, about 650 mg/L TDS, about 667 mg/L TDS, about 700 mg/L TDS, about 800 mg/L TDS, about 900 mg/L TDS, about 1,000 mg/L TDS, about 1,200 mg/L TDS, about 1,400 mg/L TDS, about 2,000 mg/L TDS, about 5,000 mg/L TDS, about 10,000 mg/L TDS, about 20,000 mg/L TDS, or about 50,000 mg/L TDS.

### Additives

In some embodiments, the fracturing fluid includes at least one of a gel stabilizer, a clay stabilizer, a viscosity breaker, a proppant, and a pH adjusting agent.

In some embodiments, the fracturing fluid contains a gel stabilizer. In some embodiments, the gel stabilizer includes an antioxidant. In some embodiments, the gel stabilizer includes phenols, polyphenols, di-tertbutyl alkyl phenols, hydroquinone, apigenin, resveratrol, ascorbic acid, tocopherol, sodium bisulfite, sodium hydrogen sulfite, sodium thiosulfate, ammonium thiosulfate, thiourea, or a combination thereof.

In some embodiments, the fracturing fluid contains a clay stabilizer. In some embodiments, the clay stabilizer includes sodium chloride, potassium chloride, ammonia chloride, tetramethylammonium chloride (TMAC), other quaternary molecules, or a combination thereof. In some embodiments, bromides, such as sodium bromide or potassium bromide, are included.

In some embodiments, the fracturing fluid includes a pH adjusting agent. For example, the fracturing fluid can include an acetic acid solution, an acetic acid/acetate buffer solution, or hydrochloric acid. In some embodiments, an acid is added to a fracturing fluid to achieve a pH between about 2 and about 7, about 3 and about 6.5, about 5 and about 5.5, about 5 and about 7, or about 5.5 and about 6.5. In some embodiments, a pH adjusting agent is needed to optimize the crosslinking at a preferred pH range. A pH adjusting agent in this case can include an acetic acid solution, an acetic acid/acetate buffer solution, or hydrochloric acid. In some embodiments, a pH adjusting agent is added to the fracturing fluid system to achieve a pH between about 2 and about 7.

### Exemplary Fracturing Fluids

In some embodiments, a fracturing fluid includes a copolymer or terpolymer, a crosslinker, a gel stabilizer, a clay stabilizer, and non-modified water-soluble graphene oxide. In some embodiments, the copolymer includes acrylamide, acrylic acid, and about 15 mol % AMPSA. The crosslinker is in the form of a crosslinking solution including about 12.4 wt % Zr. In some embodiments, the copolymer is present at a concentration of about 25 pptg, the crosslinking solution is present at a concentration of about 0.6 gpt, the gel stabilizer is present as a gel stabilizer solution at a concentration of about 2 gpt, the clay stabilizer is present as a clay stabilizer solution at a concentration of about 2 gpt, and the non-modified water-soluble graphene oxide is present at a concentration of about 1.0 pptg. In some embodiments, the pH is about 5.28.

In some embodiments, a fracturing fluid includes a copolymer or terpolymer, a crosslinker, a gel stabilizer, a clay stabilizer, and non-modified water-soluble graphene oxide. In some embodiments, the copolymer includes acrylamide, acrylic acid, and about 15 mol % AMPSA. The crosslinker is in the form of a crosslinking solution including about 12.4 wt % Zr. In some embodiments, the copolymer is present at a concentration of about 25 pptg, the crosslinking solution is present at a concentration of about 0.6 gpt, the gel stabilizer is present as a gel stabilizer solution at a concentration of about 2 gpt, the clay stabilizer is present as a clay stabilizer solution at a concentration of about 2 gpt, and the non-modified water-soluble graphene oxide is present at a concentration of about 2.0 pptg. In some embodiments, the pH is about 5.3.

In some embodiments, a fracturing fluid includes a copolymer or terpolymer, a crosslinker, a gel stabilizer, a clay stabilizer, and hydrophilically modified GO-AMPS-AA. In some embodiments, the copolymer includes acrylamide, acrylic acid, and about 15 mol % AMPSA. The crosslinker is in the form of a crosslinking solution including about 12.4 wt % Zr. In some embodiments, the copolymer is present at a concentration of about 25 pptg, the crosslinking solution is present at a concentration of about 0.6 gpt, the gel stabilizer is present as a gel stabilizer solution at a concentration of about 2 gpt, the clay stabilizer is present as a clay stabilizer solution at a concentration of about 2 gpt, and the hydrophilically modified GO-AMPS-AA is present at a concentration of about 0.25 pptg. In some embodiments, the pH is about 5.36.

In some embodiments, a fracturing fluid includes a copolymer or terpolymer, a crosslinker, a gel stabilizer, a clay stabilizer, and hydrophilically modified GO-AMPS-AA. In some embodiments, the copolymer includes acrylamide, acrylic acid, and about 15 mol % AMPSA. The crosslinker is in the form of a crosslinking solution including about 12.4 wt % Zr. In some embodiments, the copolymer is present at a concentration of about 25 pptg, the crosslinking solution is present at a concentration of about 0.6 gpt, the gel stabilizer is present as a gel stabilizer solution at a concentration of about 2 gpt, the clay stabilizer is present as a clay stabilizer solution at a concentration of about 2 gpt, and the hydrophilically modified GO-AMPS-AA is present at a concentration of about 1.0 pptg. In some embodiments, the pH is about 5.33.

In some embodiments, a fracturing fluid includes a copolymer or terpolymer, a crosslinker, a gel stabilizer, a clay stabilizer, and hydrophilically modified GO-AMPS-AA. In some embodiments, the copolymer includes acrylamide, acrylic acid, and about 15 mol % AMPSA. The crosslinker is in the form of a crosslinking solution including about 12.4 wt % Zr. In some embodiments, the copolymer is present at a concentration of about 25 pptg, the crosslinking solution is present at a concentration of about 0.6 gpt, the gel stabilizer is present as a gel stabilizer solution at a concentration of about 2 gpt, the clay stabilizer is present as a clay stabilizer solution at a concentration of about 2 gpt, and the hydrophilically modified GO-AMPS-AA is present at a concentration of about 2.0 pptg. In some embodiments, the pH is about 5.25.

### Viscosity

The fracturing fluids of the present disclosure that contain a GO additive, such as non-modified water-soluble GO or bifacial hydrophilically-modified GO nanosheets, have lower viscosities as compared to the same fracturing fluids that do not contain the GO additive. In some embodiments, the presence of the GO additive reduces the friction of the fracturing fluid as compared to the same fluid that does not contain the GO additive.

In some embodiments, the fracturing fluids of the present disclosure that contain a GO additive, such as non-modified water-soluble GO or bifacial hydrophilically-modified GO nanosheets, have a viscosity that is reduced by about 5% to about 65%, about 10% to about 65%, about 15% to about 60%, about 10% to about 50%, about 25% to about 40%, about 5% to about 10%, about 20% to about 30%, about 30% to about 40%, about 55% to about 65%, or by about 5%, about 6%, about 7%, about 10%, about 15%, about 20%, about 25%, about 26%, about 30%, about 35%, about 37%, about 40%, about 45%, about 50%, about 55%, about 60%, about 65%, or more as compared to the same fracturing fluid that does not contain the GO additive.

### Methods of Treating Subterranean Formations

Also provided in the present disclosure is a method of treating a subterranean formation, the method including introducing a fracturing fluid into the subterranean formation. In some embodiments, the fracturing fluid is a fracturing fluid of the present disclosure that contains a GO additive, such as non-modified water-soluble GO or bifacial hydrophilically-modified GO nanosheets.

Provided in the present disclosure is a method of reducing fluid friction during treatment of a subterranean formation, the method including introducing a fracturing fluid into the subterranean formation. In some embodiments, the fracturing fluid is a fracturing fluid of the present disclosure that contains a GO additive, such as non-modified water-soluble GO or bifacial hydrophilically-modified GO nanosheets. In some embodiments, the treatment is fracturing treatment.

### EXAMPLES

### Chemicals:

M1—The base polymer (terpolymer) used in the examples is in a water-in-oil emulsion form (30% active) containing 15 mol % of 2-acrylamido-2-methylpropanesulfonic acid (AMPSA), 5 mol % of acrylic acid (AA), and 80 mol % acrylamide (AM).
M2—acetic acid/acetate buffer solution.
M3—Zr crosslinker (TYZOR® 212, with 16.75 wt % ZrO₂ and 12.4 wt % Zr).
M4—gel stabilizer (CELB 225-010-2, available from ChemEOR).
M5—clay stabilizer (Cla-Web™, available from Halliburton).

### Synthesis of Hydrophilically-Modified GO-AMPS-AA

To synthesize hydrophilically-modified GO-AMPS-AA, graphene oxide (GO) nanosheets were modified with an initiator for atom-transfer radical polymerization (ATRP), then polymer was grafted from the surface using 2-acryamido-2-methyl-1-propanesulfonic acid (AMPS) and acrylic acid (AA) as monomers.

The following procedure was used. 15 mg graphene oxide (GO) was dispersed in 15 mL dimethylformamide (DMF) by sonicating for 2 hours. 200 microliters (μL) of 2-bromoisobutyryl bromide (BIBB) was added, followed by addition of 20 μL triethanolamine. The solution was stirred for 24 hours at 25° C. The product (GO-BIBB) was filtered via centrifuge and washed with DMF. The process was repeated until the desired amount of GO-BIBB was obtained. 6 g of GO-BIBB was then dispersed in DMF (1 L) by ultrasonication for 2-3 hours (with ice bath) to ensure dispersion of GO. 2-Acrylamido-2-methyl-1-propanesulfonic acid (AMPS) monomer (100 g) was dissolved in 200 mL water and the pH was adjusted to 7 with sodium hydroxide and added to the DMF solution. Acrylic acid (AA) (1:1 molar ratio of AMPS) was added to the DMF solution and the solution was transferred to a 2 L round-bottom flask. 1.5 g of copper bromide (I) was added to the mixed solution and the system was purged with N₂ for 2 hours to remove oxygen. 12 mL of 1,1,4,7,7-pentamethyldiethylenetriamine (PMTETA) was added to the solution by syringe. The flask was placed in an oil bath preheated at 80° C. for 4 days. The product was centrifuged at 4.4 krpm for 10 min to remove the DMF and then washed with water one time and ethanol three times and dried under vacuum at 50° C. to remove ethanol to obtain GO-AMPS-AA as the final product.

### Indirect Lab Measurement for Friction Change Corresponding to the Addition of the Additives

No current laboratory friction loop design can be used to measure the friction for crosslinked fluids due to their relatively high viscosity range in comparison to the linear fluids which are commonly used in the slickwater treatment. Accordingly, viscosity measurements were used as a proxy to indirectly indicate the friction change with addition of the proposed hydrophilically-modified GO.

“Cup and bob” is a type of rotational rheometer (viscometer) that is based on measuring the torque required to turn an object in a fluid. The torque is a function of the viscosity of the fluid, and is measured at a constant angular velocity. Since viscosity is normally considered in terms of shear stress and shear rates (Eq. 1), a method was needed to convert from instrument numbers to rheology numbers. Each measuring system used in an instrument has its associated form factors to convert torque to shear stress and to convert angular velocity to shear rate. In Eq. 2 and Eq. 3, C₁ is used as the shear stress form factor; C₂ is used as the shear rate factor.

$$Viscosity = shear stress / shear rate \\ Where : \qquad ( Eq . 1 )$$

$$Shear stress = torque \div {C}_{1} \qquad ( Eq . 2 )$$

$$Shear rate = {C}_{2} \times angular velocity \qquad ( Eq . 3 )$$

In coaxial cylinder design such as “cup and bob,”

$${C}_{1} = \frac{1}{3} {r}_{a}^{2} H \qquad ( Eq . 4 )$$

$${C}_{2} = \frac{2 {r}_{i}^{2} {r}_{o}^{2}}{{r}_{a}^{2} ( {r}_{o}^{2} - {r}_{i}^{2} )} \qquad ( Eq . 5 )$$

Where:
rₐ=(rᵢ+rₒ)/2 is the average radius,
rᵢ is the inner radius,
rₒ is the outer radius,
H is the height of cylinder

Thus, viscosity is proportional to the torque. Under the same shear rate, a higher viscosity measurement indicates higher torque, which indicates higher friction during shear. Since the viscosity measurement from the rotational rheometer is related to the torque (moment, M) reading, the viscosity change among different fluid system is expected to reflect the torque changes. As described below, the fluid viscosity was measured under high temperature and high pressure conditions for the desired fluid systems.

### Viscosity Measurement Under High Temperature and High Pressure

To measure the viscosity of fracturing fluid systems under high temperature and high pressure subterranean reservoir formation, sample volumes of about 100 mL were generally prepared for each test and 50 mL aliquots of each fracturing fluid system were injected into a Grace M5600 HPHT rheometer equipped with a B5 bob configuration. Tests were performed using a heating profile and a constant shear rate of 100 s−1.

### Example 1

A fracturing fluid that included synthetic field water (shown in Table 1), 25 pound per one thousand gallon (pptg) M1 terpolymer, 4.5 gallon per one thousand gallon buffer solution M2, 2 gpt gel stabilizer M4, 2 gpt clay stabilizer M5, and 0.6 gpt Zr crosslinker (M3) was prepared. The pH of the mixed fluid was 5.38. The viscosity of the resulting crosslinked fracturing fluid at shear rate of 100 s⁻¹ was measured at 300° F.

TABLE 1
Water Analysis of the formation water.

| Component | Concentration (mg/L) |
|---|---|
| Calcium | 0.27 |
| Magnesium | 1.56 |
| Chloride | 266 |
| Sulfate | 201 |
| Bicarbonate | 198 |

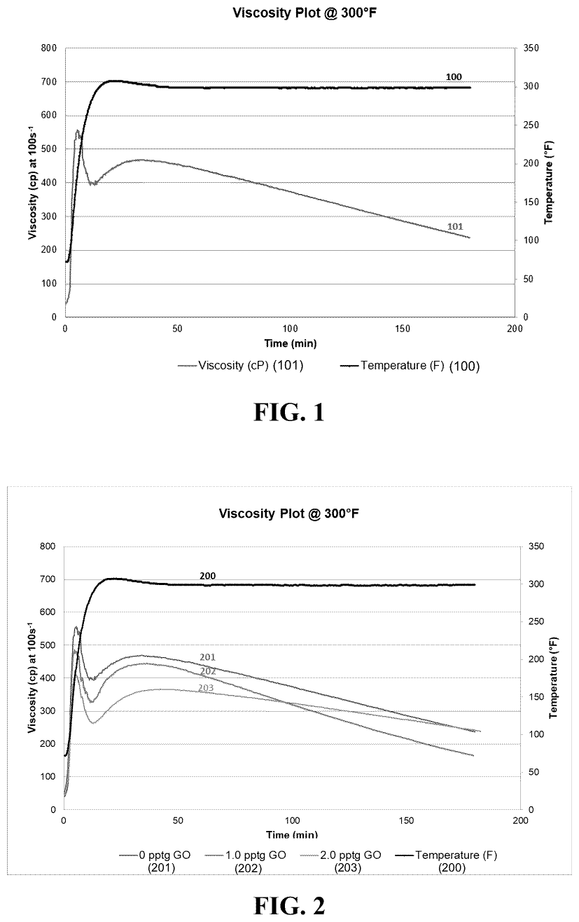

Plot 100 in FIG. 1 shows temperature versus time, and plot 101 shows viscosity versus time for the crosslinked fracturing fluid. The fracturing fluid maintained a viscosity of greater than 300 cP at a shear rate of 100 s⁻¹ for more than 140 min under 300° F.

### Example 2

A non-modified graphene oxide was used as the additive to reduce the friction of the crosslinked fracturing fluid. In the typical fluid preparation procedure, the required amount of GO is sonicated in synthetic field water for half an hour before hydrating the base polymer.

Fracturing fluids that included synthetic field water (shown in Table 1), 25 pound per one thousand gallon (pptg) M1 terpolymer, 4.5 gallon per one thousand gallon buffer solution M2, 2 gpt gel stabilizer M4, 2 gpt clay stabilizer M5, 0.6 gpt Zr crosslinker (M3), and either 1.0 pptg or 2.0 pptg of non-modified graphene oxide GO as the fluid additive were prepared. The pH of the mixed fluid that contained 1.0 pptg GO was 5.28 and pH of the mixed fluid that contained 2.0 pptg GO was 5.30. Viscosity of the resulting crosslinked fracturing fluids at a constant shear rate of 100 s−1 was measured at 300° F.

FIG. 2 shows viscosity of fracturing fluids with addition of non-modified GO at different concentrations. Plot 200 in FIG. 2 shows temperature versus time; plot 201 shows viscosity versus time for the fluid formulation prepared in Example 1 (plot 101 in FIG. 1; no addition of GO); plot 202 shows viscosity versus time for the formulation that contained 1.0 pptg GO; and plot 203 shows viscosity versus time for the formulation that contained 2.0 pptg GO.

It can be seen that with addition of 1.0 pptg of non-modified GO, the viscosity curve for plot 202 was relatively lower than plot 201, which is opposite of what would be expected for a typical synergistic fluid system (a viscosity increase with addition of nanoparticles or nanosheets). With addition of 2.0 pptg of the non-modified GO, the viscosity for plot 203 was further reduced than plot 202.

Table 2 shows the viscosities of the formulation prepared in Example 1 and the two formulations of this Example at 100 s−1 at testing time of 25 min. The percentage of viscosity reduction over Example 1 (no additive) with the two different amounts of non-modified GO as an additive was calculated as well.

TABLE 2
Viscosity (@ 100 s⁻¹ shear rate; 300° F.) at testing time of 25 min.

| | Additive | Viscosity | Viscosity |
|---|---|---|---|
| | Concentration | at 25 min | Reduction |
| Formulation | (pptg) | (cP at 100 s⁻¹) | (%) |
| #1 (no additive) | 0 | 456 | — |
| #2 (1.0 pptg GO) | 1.0 | 428 | 6.1 |
| #3 (2.0 pptg GO) | 2.0 | 335 | 26.5 |

### Example 3

The hydrophilically modified graphene oxide GO-AMPS-AA was used as the additive to reduce the friction of the crosslinked fracturing fluid. In the typical fluid preparation procedure, the required amount of GO-AMPS-AA is sonicated in synthetic field water for half an hour before hydrating the base polymer. In the field operation, the GO-AMPS-AA additive can be added as a dry powder additive or remain as the wet form after synthesis without a drying process before hydrating the base polymer.

Fracturing fluids that included synthetic field water (shown in Table 1), 25 pound per one thousand gallon (pptg) M1 terpolymer, 4.5 gallon per one thousand gallon buffer solution M2, 2 gpt gel stabilizer M4, 2 gpt clay stabilizer M5, 0.6 gpt Zr crosslinker (M3), and either 0.25 pptg, 1.0 pptg, or 2.0 pptg of hydrophilically-modified graphene oxide GO-AMPS-AA, were prepared. The pH of the mixed fluid that contained 0.25 pptg GO-AMPS-AA was 5.36, the pH of the mixed fluid that contained 1.0 pptg GO-AMPS-AA was 5.33, and pH of the mixed fluid that contained 2.0 pptg GO-AMPS-AA was 5.25. Viscosity of the resulting crosslinked fracturing fluids at a constant shear rate of 100 s⁻¹ was measured at 300° F.

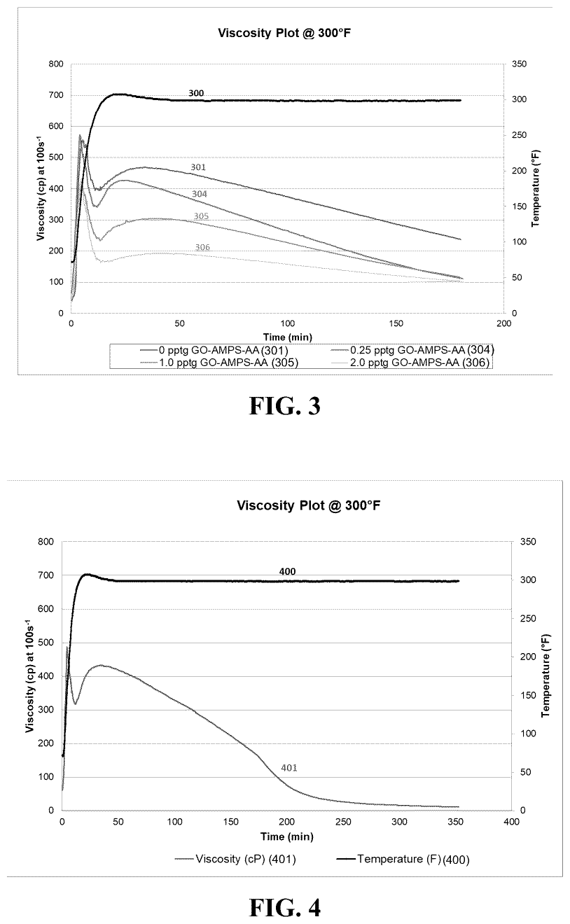

FIG. 3 shows viscosity of fracturing fluids with addition of hydrophilic-modified GO (GO-AMPS-AA) at different concentrations. Plot 300 in FIG. 3 shows temperature versus time; plot 301 shows viscosity versus time for the fluid formulation prepared in Example 1 (plot 101 in FIG. 1; no addition of GO-AMPS-AA); plot 304 shows viscosity versus time for the formulation that contained 0.25 pptg GO-AMPS-AA; plot 305 shows viscosity versus time for the formulation that contained 1.0 pptg GO-AMPS-AA; plot 306 shows viscosity versus time for the formulation that contained 2.0 pptg GO-AMPS-AA.

It can be seen that with addition of 0.25 pptg of the hydrophilic-modified GO additive GO-AMPS-AA, the viscosity curve for plot 304 was relative lower than plot 301, which is opposite of what would be expected for a typical synergistic fluid system (the viscosity increases with addition of nanoparticles or nanosheets). With addition of 1.0 pptg of the additive GO-AMPS-AA, the viscosity for plot 305 was further reduced than plot 304. When the GO-AMPS-AA concentration increased to 2.0 pptg (plot 306), the viscosity in plot 306 was further reduced than what was in plot 305.

Table 3 shows the viscosities of the formulation prepared in Example 1 and the three formulations of this Example at 100 s−1 at testing time of 25 min. The percentage of viscosity reduction over Example 1 (no additive) with three different amounts of hydrophilically-modified GO (GO-AMPS-AA) as an additive was calculated as well.

TABLE 3
Viscosity (@ 100 s⁻¹ shear rate; 300° F.) at testing time of 25 min.

| | Additive | Viscosity | Viscosity |
|---|---|---|---|
| | Concen- | at 25 min | Re- |
| | tration | (cP at | duction |
| Formulation | (pptg) | 100 s⁻¹) | (%) |
| #1 (no additive) | 0 | 456 | — |
| #4 (0.25 pptg GO-AMPS-AA) | 0.25 | 426 | 6.6 |
| #5 (1.0 pptg GO-AMPS-AA) | 1.0 | 289 | 36.6 |
| #6 (2.0 pptg GO-AMPS-AA) | 2.0 | 180 | 60.5 |

### Example 4

Encapsulated high temperature ProCap BR (product from Fritz) was added to examine cleanup of the high temperature fracturing fluid described in the Examples. Here, 4 pptg ProCap BR (24 mg per 50 mL of the fluid) was added to the fluid formulation #4 of Example 3 that contained 0.25 pptg GO-AMPS-AA. The pH of the mixed fluid was 5.34. Viscosity of the resulting crosslinked fracturing fluid at shear rate of 100s⁻¹ was measured at 300° F.

FIG. 4 shows the breaking profile of the fluid at 300° F. Plot 400 in FIG. 4 shows temperature versus time; and plot 401 shows viscosity versus time with addition of 4 pptg of encapsulated breaker (ProCap BR). As can be seen, the water-soluble GO-assisted fluid with addition of 0.25 pptg GO-AMPS-AA can achieve fully broken with encapsulated oxidizers.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1.-17. (canceled)

18. A method of treating a subterranean formation, the method comprising:
introducing a fracturing fluid into a subterranean formation, the fracturing fluid comprising:
an aqueous copolymer composition comprising a terpolymer comprising 2-acrylamido-2-methylpropanesulfonic acid, acrylamide, and acrylic acid monomer units, or a salt thereof;
a graphene oxide (GO) additive selected from a non-modified water-soluble graphene oxide and a bifacial hydrophilically-modified GO-AMPS-AA; and
a crosslinker comprising a metal; and
crosslinking the fracturing fluid in the subterranean formation to yield a crosslinked fracturing fluid.

19. The method of claim 18, wherein the fracturing fluid comprises about 0.01 pptg to about 20 pptg of the graphene oxide additive.

20. A method of reducing fluid friction during treatment of a subterranean formation, the method comprising:
introducing a fracturing fluid into a subterranean formation, the fracturing fluid comprising:
an aqueous copolymer composition comprising a terpolymer comprising 2-acrylamido-2-methylpropanesulfonic acid, acrylamide, and acrylic acid monomer units, or a salt thereof;
a graphene oxide (GO) additive selected from a non-modified water-soluble graphene oxide and a bifacial hydrophilically-modified GO-AMPS-AA; and
a crosslinker comprising a metal; and
crosslinking the fracturing fluid in the subterranean formation to yield a crosslinked fracturing fluid.

21. The method of claim 20, wherein the fracturing fluid comprises about 0.01 pptg to about 20 pptg of the graphene oxide additive.

22. The method of claim 18, wherein the terpolymer comprises about 1 mol % to about 55 mol % of the 2-acrylamido-2-methylpropanesulfonic acid monomer units.

23. The method of claim 18, wherein the fracturing fluid comprises about 15 to about 50 pounds of the copolymer per thousand gallons (pptg) of the fracturing fluid.

24. The method of claim 18, wherein the crosslinker comprises zirconium, titanium, or chromium.

25. The method of claim 18, wherein the weight ratio of the metal to the terpolymer is in a range of 0.01 to 0.10.

26. The method of claim 18, wherein the fracturing fluid comprises at least one of a gel stabilizer, a clay stabilizer, a viscosity breaker, a proppant, and a pH adjusting agent.

27. The method of claim 26, wherein the fracturing fluid comprises the pH adjusting agent, wherein the pH of the fracturing fluid is between about 2 to about 7.

28. The method of claim 18, wherein the fracturing fluid comprises between about 250 mg/L and about 50,000 mg/L of total dissolved solids.

29. The method of claim 18, wherein the fracturing fluid has a viscosity that is reduced by about 5% to about 65% as compared to the same fracturing fluid that does not contain the graphene oxide additive.

30. The method of claim 20, wherein the terpolymer comprises about 1 mol % to about 55 mol % of the 2-acrylamido-2-methylpropanesulfonic acid monomer units.

31. The method of claim 20, wherein the fracturing fluid comprises about 15 to about 50 pounds of the copolymer per thousand gallons (pptg) of the fracturing fluid.

32. The method of claim 20, wherein the crosslinker comprises zirconium, titanium, or chromium.

33. The method of claim 20, wherein the weight ratio of the metal to the terpolymer is in a range of 0.01 to 0.10.

34. The method of claim 20, wherein the fracturing fluid comprises at least one of a gel stabilizer, a clay stabilizer, a viscosity breaker, a proppant, and a pH adjusting agent.

35. The method of claim 34, wherein the fracturing fluid comprises the pH adjusting agent, wherein the pH of the fracturing fluid is between about 2 to about 7.

36. The method of claim 20, wherein the fracturing fluid comprises between about 250 mg/L and about 50,000 mg/L of total dissolved solids.

37. The method of claim 20, wherein the fracturing fluid has a viscosity that is reduced by about 5% to about 65% as compared to the same fracturing fluid that does not contain the graphene oxide additive.
